(19) United States
(12) Patent Application Publication
(10) Pub. No.: US 2013/0104606 A1
(43) Pub. Date: May 2, 2013

(54) WATER PURIFICATION SYSTEM AND WASHING MACHINE HAVING THE SAME

(71) Applicant: SAMSUNG ELECTRONICS CO., LTD., Suwon (KR)

(72) Inventors: Sang Young SO, Yongin (KR); Kwang Hyok PARK, Suwon (KR); Dae Wook PARK, Hwaseong (KR); Kyu Ho SHIN, Seoul (KR); Jai Kwon LEE, Suwon (KR); Seok Man HONG, Gwangju (KR)

(73) Assignee: SAMSUNG ELECTRONICS CO., LTD., Suwon (KR)

(21) Appl. No.: 13/659,182

(22) Filed: Oct. 24, 2012

(30) Foreign Application Priority Data
Nov. 1, 2011 (KR) 10-2011-0112646

(51) Int. Cl. D06F 35/00; C02F 1/72; B01D 37/00

(52) U.S. Cl. 68/13 R; 210/323.1; 210/758

(57) ABSTRACT

A water purification system and a washing machine having the same. The water purification system includes a filter unit to physically filter out contaminants from washing water or rinsing water after a washing process or a rinsing process, and at least one advanced oxidation process (AOP) unit to purify the washing water or the rinsing water, from which the contaminants have been filtered out, using a photocatalyst so as to reuse the washing water or the rinsing water. The water purification system purifies washing water or rinsing water used in a washing process or a rinsing process and then reuses the purified washing or rinsing water in the next washing or rinsing process, thereby saving water.

### CROSS-REFERENCE TO RELATED APPLICATIONS

This application claims the priority benefit of Korean Patent Application No. 10-2011-0112646, filed on Nov. 1, 2011 in the Korean Intellectual Property Office, the disclosure of which is incorporated herein by reference.

### BACKGROUND

1. Field

The following description relates to a water purification system and a washing machine having the same.

2. Description of the Related Art

In general, a drum washing machine, water is supplied to the inside of a drum and is mixed with detergent to make washing water, and then a washing process of laundry is performed. When surface tension of water is reduced by a surface active agent contained in the detergent, washing water permeates gaps of a fabric. Then, the surface active agent surrounds contaminating components attached to the fabric A hydrophobic group, i.e., a lipophilic group, of the surface active agent is attached to the contaminating components. The contaminating components are present within the washing water when they are surrounded by the surface active agent and are separated from the fabric. Such waste water containing turbidity components is drained to the outside of the washing machine. Thereafter, new rinsing water is supplied to the inside of the drum, and then a washing process and a rinsing process are carried out.

Due to these series of washing and rinsing operations, a large amount of water is supplied to the inside of the drum as rinsing water and is discarded. Particularly, the amount of water used as the rinsing water increases by geometric progression according to the number of times of the rinsing operation.

Conventionally, in order to save water, waste water obtained by the final rinsing process is stored in a water tank, and is used as washing water during the next washing operation or is reused in a toilet.

However, in such a conventional washing machine, the water tank to store final washing water or final rinsing water after the washing process or the rinsing process may be separately provided, and thus a spatial limitation may be required in design of the washing machine. Further, if the final washing water or rinsing water is stored within the water tank for a long time, bad smells or hygiene problems occur.

### SUMMARY

Therefore, it is an aspect of the present disclosure to provide a water purification system which purifies washing water or rinsing water used in washing of laundry and is then reused in the next washing process or rinsing process to save water, and a washing machine having the same.

Additional aspects of the disclosure will be set forth in part in the description which follows and, in part, will be apparent from the description, or may be learned by practice of the disclosure.

In accordance with one aspect of the present disclosure, a water purification system includes a filter unit to physically filter out contaminants from washing water or rinsing water after a washing process or a rinsing process, and at least one advanced oxidation process (AOP) unit to purify the washing water or the rinsing water, from which the contaminants have been filtered out, using a photocatalyst so as to reuse the washing water or the rinsing water.

The unit may be a membrane filter or an electrostatic filter.

The at least one AOP unit may include a cylindrical chemical reactor, the inner surface of which is coated with the photocatalyst, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor, and a lamp located within the chemical reactor and generating ultraviolet light of a wavelength of 185 nm and ultraviolet light of a wavelength of 254 nm.

The at least one AOP unit may further include a protective pipe formed of quartz and surrounding the lamp to protect the lamp.

The protective pipe may be a greater length than the length of the lamp.

The inlet may be provided at one end of the outer surface of the chemical reactor, and the outlet may be provided at the other end of the outer surface of the chemical reactor.

The protective pipe may have a smaller length than the length of the lamp, and is provided with an opened end through which one end of the lamp passes.

The inlet and the outlet may be opposite each other at one end of the outer surface of the chemical reactor.

The water purification system may further include a mesh coated with the photocatalyst and provided between the protective pipe and the chemical reactor.

The at least one AOP unit may further include a spiral channel guide provided along the inner surface of the chemical reactor.

The at least one AOP unit may further include a mesh coated with the photocatalyst and provided between the channel guide and the inner surface of the chemical reactor.

The at least one AOP unit may include a cylindrical chemical reactor, the inner surface of which is coated with a reflective material reflecting ultraviolet light generated from a lamp to the inside of the chemical reactor, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor, the lamp located within the chemical reactor and generating ultraviolet light of a wavelength of 185 nm and ultraviolet light of a wavelength of 254 nm, and reflective mirrors provided at both ends of the lamp to reflect the ultraviolet light generated from the lamp to the inside of the chemical reactor.

The photocatalyst may be titanium dioxide (TiO2).

In accordance with another aspect of the present disclosure, a washing machine includes a drum accommodating laundry, a motor rotating the drum, and a water purification system including a filter unit physically to filter out contaminants from washing water or rinsing water discharged from the drum, and at least one advanced oxidation process (AOP) unit to purify the washing water or the rinsing water, from which the contaminants have been filtered out, using a photocatalyst so as to reuse the washing water or the rinsing water in the next process.

The filter unit may have a membrane filter or an electrostatic filter.

The at least one AOP unit may include a cylindrical chemical reactor, the inner surface of which is coated with the photocatalyst, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor, and a lamp located within the chemical reactor and generating ultraviolet light of a wavelength of 185 nm and ultraviolet light of a wavelength of 254 nm.

The at least one AOP unit may further include a protective pipe formed of quartz and surrounding the lamp to protect the lamp.

The protective pipe may have a greater length than the length of the lamp.

The inlet may be provided at one end of the outer surface of the chemical reactor, and the outlet may be provided at the other end of the outer surface of the chemical reactor.

The protective pipe may have a smaller length than the length of the lamp, and is provided with an opened end through which one end of the lamp passes.

The inlet and the outlet may be opposite each other at one end of the outer surface of the chemical reactor.

The washing machine may further include a mesh coated with the photocatalyst and provided between the protective pipe and the chemical reactor.

The at least one AOP unit may further include a spiral channel guide provided along the inner surface of the chemical reactor.

The at least one AOP unit may further include a mesh coated with the photocatalyst and provided between the channel guide and the inner surface of the chemical reactor.

The at least one AOP unit may include a cylindrical chemical reactor, the inner surface of which is coated with a reflective material reflecting ultraviolet light generated from a lamp to the inside of the chemical reactor, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor, the lamp located within the chemical reactor and generating ultraviolet light of a wavelength of 185 nm and ultraviolet light of a wavelength of 254 nm, and reflective mirrors provided at both ends of the lamp to reflect the ultraviolet light generated from the lamp to the inside of the chemical reactor.

The photocatalyst may be titanium dioxide (TiO2).

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a block diagram illustrating the schematic configuration of a washing machine having a water purification system in accordance with an embodiment of the present disclosure;

FIG. 2 is a view illustrating an arrangement of the water purification system in accordance with an embodiment of the present disclosure;

FIG. 3 is a view specifically illustrating the water purification system of FIG. 2;

FIG. 4 is a view illustrating another arrangement of the water purification system in accordance with an embodiment of the present disclosure;

FIG. 5 is a view illustrating a principle by which contaminants are filtered out from rinsing water by a filter unit of the water purification system;

FIG. 6 is a view illustrating the structure of an advanced oxidation process unit in accordance with an embodiment of the present disclosure;

FIG. 7 is a view illustrating the structure of an advanced oxidation process unit in accordance with another embodiment of the present disclosure;

FIG. 8 is a view illustrating the structure of an advanced oxidation process unit in accordance with another embodiment of the present disclosure;

FIG. 9 is a view illustrating the structure of an advanced oxidation process unit in accordance with another embodiment of the present disclosure;

FIG. 10 is a view illustrating the structure of an advanced oxidation process unit in accordance with another embodiment of the present disclosure;

FIG. 11 is a view illustrating the structure of an advanced oxidation process unit in accordance with another embodiment of the present disclosure;

FIG. 12 is a view illustrating the structure of an advanced oxidation process unit in accordance with another embodiment of the present disclosure;

FIG. 13 is a view illustrating the structure of an advanced oxidation process unit in accordance with yet another embodiment of the present disclosure;

FIG. 14 is a flowchart illustrating a rinsing process performed in a washing machine in accordance with an embodiment of the present disclosure; and

FIGS. 15 and 16 are graphs illustrating effects of a water purification system in accordance with an embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

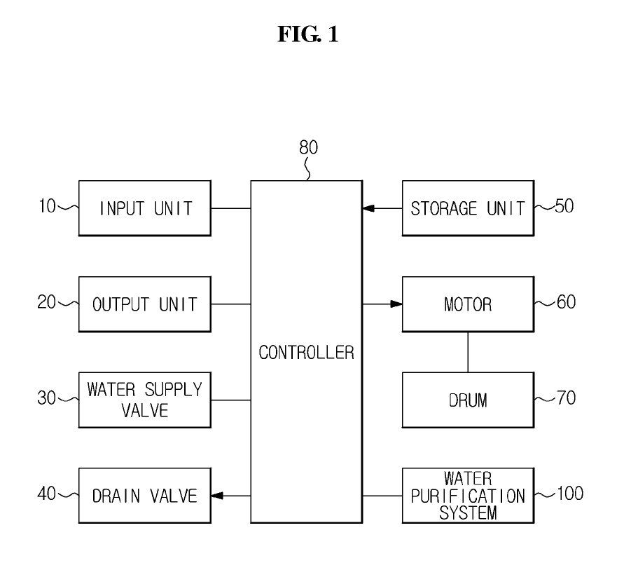

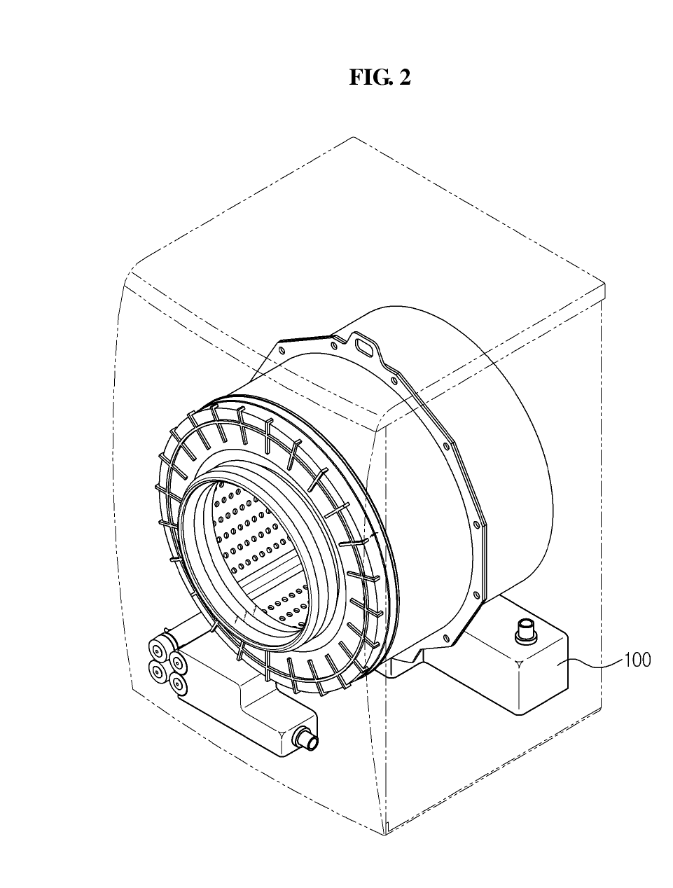

FIG. 1 is a block diagram illustrating the schematic configuration of a washing machine in accordance with an embodiment of the present disclosure. As shown in FIG. 1, the washing machine includes an input unit 10, an output unit 20, a drum 70, a motor 60, a water supply valve 30, a drain valve 40, a controller 80, a storage unit 50 and a water purification system 100.

The input unit 10 receives a command relating to washing operations from a user. For this purpose, the input unit 10 may include a plurality of buttons.

The output unit 20 outputs results of the command processed as sound, text, or an image. For this purpose, the output unit 20 may include at least one of an image display unit, such as a liquid crystal display (LCD), and a sound output unit, such as a speaker. The output unit 20 may be hardware provided separately from the input unit 10, or may be hardware integrated with the input unit 10, such as a touch screen or a touch pad.

The user puts laundry to be washed into the drum 70. The drum 70 may be rotated by the motor 60.

The motor 60 rotates the drum 70 so as to perform a washing process and a rinsing process.

The water supply valve 30 is a valve connected to a water supply pipe (not shown), and when the water supply valve 30 is opened, water is supplied to the inside of the drum 70 through the water supply pipe.

The controller 80 serves to control and connect the respective components within the washing machine. For example, if the user selects a designated washing process, the controller 80 controls the respective components of the washing machine so as to perform a rinsing process and a spin-drying process according to the selected washing process.

The storage unit 50 may store data and algorithm necessary to wash laundry. For example, the storage unit 50 may store information regarding kinds of washing processes, data necessary to measure the weight or volume of laundry, etc. Such a storage unit 50 may be, for example, a non-volatile memory, or a combination of volatile and non-volatile memories.

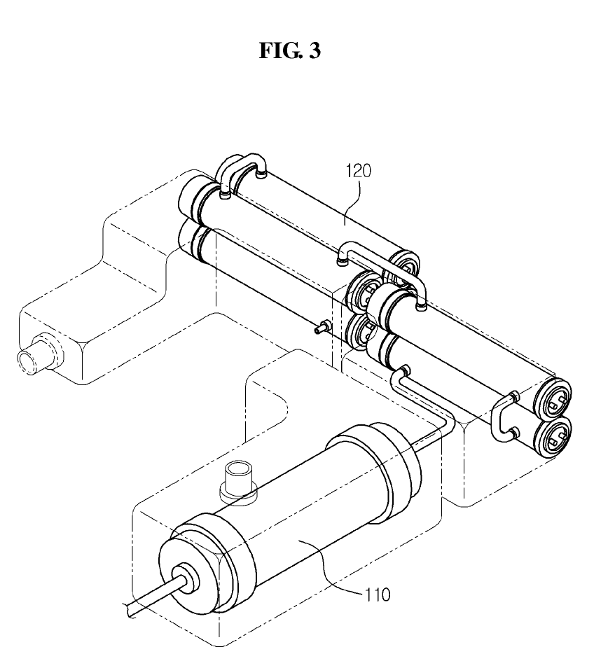

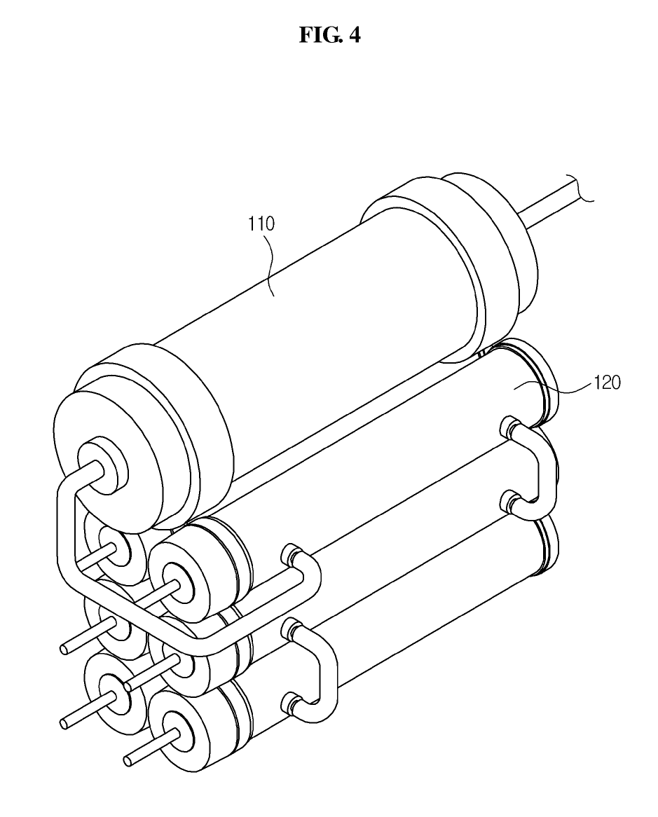

The water purification system 100 purifies rinsing water used in the rinsing process and then discharged from the drum 70. The water purification system 100 may be properly disposed within the washing machine. As an example, as shown in FIG. 3, the water purification system 100 may be disposed at the lower portion of the washing machine. As another example, the water purification system 100 may be disposed in a manner shown in FIG. 4. The water purification system 100 includes a filter unit 110 and advanced oxidation process (AOP) units 120. Rinsing water discharged from the drum 70 sequentially passes through the filter unit 110 and the AOP units 120, and is then discharged to the outside of the washing machine.

The filter unit 110 physically filters contaminants having a comparatively large particle size out from contaminants present in rinsing water. In more detail, when contaminant components present in a fabric and a surface active agent of detergent meet, colloid particles are formed. These colloid particles have a diameter of about 5˜200 nm. The colloid particles include micelles having a relatively small diameter and liposomes having a relatively large diameter, and the filter unit 110 filters liposomes out from rinsing water.

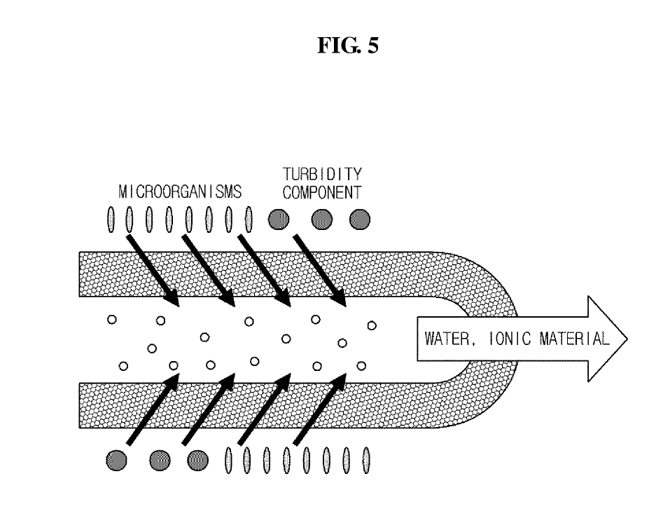

As an example, the filter member 110 may be a membrane filter. As the membrane filter, a microfiltration filter having a pore size of 0.1 μm or an ultrafiltration filter having a pore size of 0.01 μm may be used. If the filter member 110 is a membrane filter, contaminants having a relatively large size are removed from rinsing water by the filter, as shown in FIG. 5.

As another example, the filter member 110 may be an electrostatic filter. The electrostatic filter includes a nano alumina filter having a diameter of 2 nm. Such an electrostatic filter has a strong positive electrostatic charge in an aqueous solution, and removes detergent having a negative charge from rinsing water.

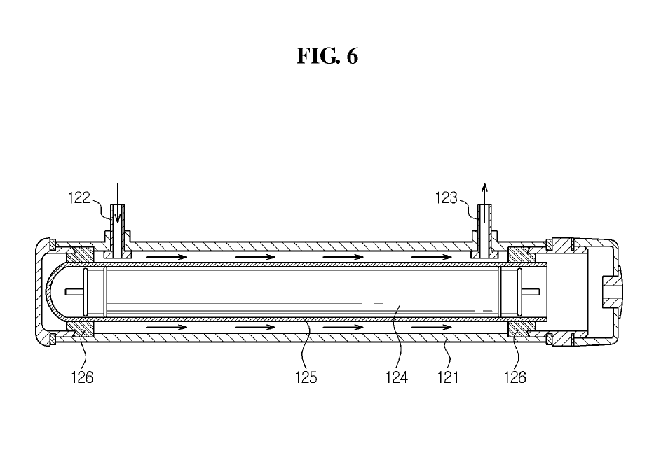

The AOP units 120 decompose a detergent component present in rinsing water using a photocatalyst. Further, the AOP units 120 serve to sterilize rinsing water. Although FIGS. 3 and 4 illustrate six AOP units 120, the present disclosure is not limited thereto. The number of the AOP units 120 may be varied according to the overall size of the water purification system 100 or water purifying or sterilizing effects required by the water purification system 100. Hereinafter, with reference to FIGS. 6 to 13, the structure of the AOP units 120 will be described in more detail.

FIG. 6 is a view illustrating the structure of an AOP unit 120 in accordance with an embodiment of the present disclosure.

As shown in FIG. 6, the AOP unit 120 may include a chemical reactor 121, a lamp 124 located within the chemical reactor 121, and a protective pipe 125 surrounding the lamp 124.

The chemical reactor 121 may be formed in a cylindrical shape, the upper or lower surface of which is opened. The chemical reactor 121 may be formed of, for example, stainless steel (SUS), and the inner surface of the chemical reactor 121 may be coated with a photocatalyst. The photocatalyst may be titanium dioxide (TiO2), but is not limited thereto. An inlet 122 through which rinsing water discharged from the filter unit 110 is introduced into the chemical reactor 121 and an outlet 123 through which water purified and sterilized by photocatalyst reaction is discharged from the chemical reactor 121 are provided on the outer surface of the chemical reactor 121. The inlet 122 may be provided at one end of the chemical reactor 121, and the outlet 123 may be provided at the other end of the chemical reactor 121. The inlet 122 of the chemical reactor 121 may be connected to the filter unit 110 through a hose (not shown), and the outlet 123 of the chemical reactor 121 may be connected to an inlet of another AOP unit 120 through a hose (not shown).

The lamp 124 may be an ozone lamp generating ultraviolet light of a specific wavelength. In more detail, ultraviolet light (UV) is divided into UV-A, UV-B and UV-C according to wavelengths, and the lamp 124 may be an ozone lamp generating ultraviolet light of a wavelength of 185 nm and ultraviolet light of a wavelength of 254 nm from among UV-C.

The protective pipe 125 surrounds the lamp 124 to protect the lamp 124. Further, the protective pipe 125 serves to electrically insulate the lamp 124 from rinsing water introduced into the chemical reactor 121 and to achieve heat insulation between rinsing water and the lamp 124. The protective pipe 125 may be formed of, for example, quartz. One end of the protective pipe 125 is opened and the other end of the protective pipe 125 is closed. Therefore, the lamp 124 is inserted into the protective pipe 125 through the opened end of the protective pipe 125, and the protective pipe 125 with the inserted lamp 124 is inserted into the chemical reactor 121 through the opened end of the chemical reactor 121. Since the diameter of the chemical reactor 121 is greater than the diameter of the protective pipe 125, circular packings 126 are provided between the inner surface of the chemical reactor 121 and the outer surface of the protective pipe 125 so as to prevent rinsing water introduced into the chemical reactor 121 from leaking to the outside of the chemical reactor 121.

The protective pipe 125 may have a structure, one end of which is closed, as described above, or may have a structure, both ends of which are opened. When the structure of the protective pipe 125, both ends of which are opened, the chemical reactor 121 may have a cylindrical shape, the upper and lower surfaces of which are opened. Further, a packing 126 may be provided at each of both ends of the protective pipe 125.

Further, a lid (not shown in FIG. 6) covering the packing 126 may be provided at each of both ends of the protective pipe 125.

Hereinafter, a purification process and a sterilization process of rinsing water performed in the AOP unit 120 having the above-described structure will be described below.

First, the purification process of rinsing water will be described. When power is supplied to the lamp 124, the lamp 124 generates, for example, ultraviolet light of a wavelength of 185 nm and ultraviolet light of a wavelength of 254 nm. Then, the ultraviolet light of a wavelength of 254 nm supply energy to titanium dioxide (TiO2), and electrons are emitted from a valence band of titanium dioxide (TiO2) and move to a conduction band. Thereby, electron holes are formed in the valence band. The electrons in the conduction band and the electron holes in the valence band react with water and dissolved oxygen in rinsing water and thus generate hydroxyl radicals (OH). A detergent component contained in rinsing water is decomposed into water (H2O) and carbon dioxide (CO2) by the hydroxyl radicals (OH). Further, from among the ultraviolet light generated from the lamp 124, the ultraviolet light of a wavelength of 185 nm generates ozone (O3). Ozone (O3) additionally generates hydroxyl radicals (OH).

Next, the sterilization process of rinsing water will be described. Sterilization of rinsing water is performed by ultraviolet light of a wavelength of 254 nm and hydroxyl radicals (OH). Ultraviolet light of a wavelength of 254 nm has the strongest sterilizing power from among wavelengths belonging to UV-C, thus exhibiting a sterilizing action upon rinsing water. Further, ozone (O3) generated by ultraviolet light of a wavelength of 185 nm may exhibit a deodorizing action upon rinsing water, and may exhibit a sterilizing action upon a portion of rinsing water which ultraviolet light does not influence.

In order to increase purifying and sterilizing effects of rinsing water, the structure of the AOP unit 120 may be modified in various ways. In more detail, as methods to increase purifying and sterilizing effects of rinsing water, there are a method of increasing an amount of photoreaction to increase an amount of generated hydroxyl radicals (OH), and a method of increasing photocatalyst reaction time to increase an amount of generated hydroxyl radicals (OH).

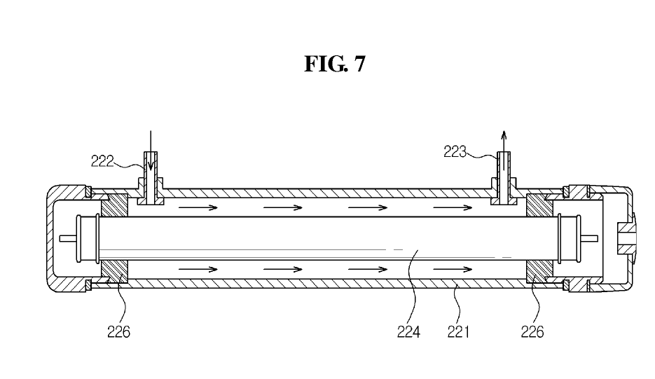

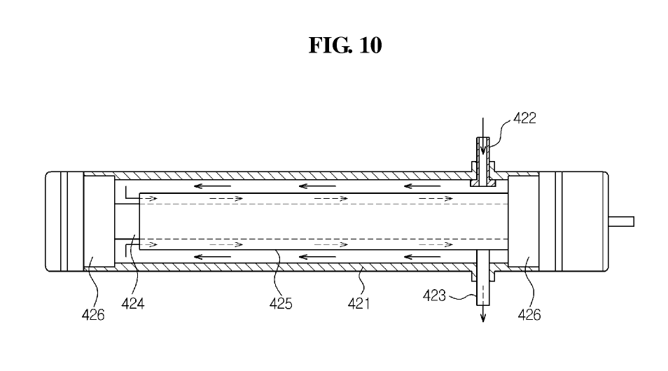

Hereinafter, the structures of AOP units relating to the former will be described with reference to FIGS. 7 to 9, and the structures of AOP units relating to the latter will be described with reference to FIGS. 10 to 13. Further, for convenience of description, a detailed description of components of these AOP units which are the same as those of the AOP unit 120 shown in FIG. 6 will be omitted.

FIG. 7 is a view illustrating the structure of an advanced oxidation process unit in accordance with another embodiment of the present disclosure. With reference to FIG. 7, the AOP unit includes a cylindrical chemical reactor 221, the upper and lower surfaces of which are opened, and a lamp 224 located within the chemical reactor 221, packings 226 provided at each of both ends of the lamp 224, an inlet 222 provided at one end of the chemical reactor 221, an outlet 223 provided at the other end of the chemical reactor 221 and a protective pipe surrounding the lamp 224 is omitted. If the protective pipe is omitted, an amount of hydroxyl radicals (OH) generated by ultraviolet light of a wavelength of 185 nm is increased, as compared to the amount of hydroxyl radicals (OH) if the protective pipe is provided. In more detail, from among ultraviolet light generated from the lamp 224, ultraviolet light of a wavelength of 185 nm is absorbed by air. If the protective pipe surrounding the lamp 224 is provided, ultraviolet light of a wavelength of 185 nm is absorbed by air present between the lamp 224 and the protective pipe. As a result, an amount of ozone (O3) generated by ultraviolet light of a wavelength of 185 nm is reduced, and reduction of the amount of ozone (O3) causes reduction of hydroxyl radicals (OH). Therefore, if the protective pipe is omitted, as shown in FIG. 7, ultraviolet light of a wavelength of 185 nm is prevented from being absorbed by air, and thus reduction of hydroxyl radicals (OH) may be prevented.

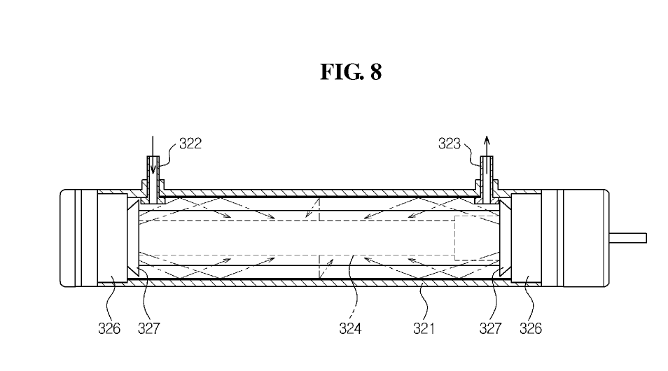

FIG. 8 is a view illustrating the structure of an advanced oxidation process unit in accordance with another embodiment of the present disclosure. With reference to FIG. 8, the AOP unit includes a cylindrical chemical reactor 321, the upper and lower surfaces of which are opened, a lamp 324 located within the chemical reactor 321, a reactive mirror 327, a packing 326 are provided at each of both ends of the lamp 324, an inlet 322 provided at one end of the chemical reactor 321, an outlet 323 provided at the other end of the chemical reactor 321. In this case, the inner surface of the chemical reactor 321 may be coated with a material to reflect ultraviolet light generated from the lamp 324, instead of titanium dioxide (TiO2). Ultraviolet light generated from the lamp 324 is reflected by the material coating the inner surface of the chemical reactor 321 and the reflective mirrors 327 located at both ends of the lamp 324 and an amount of light necessary for photocatalyst reaction increases by an amount of the reflected ultraviolet light, and thus an amount of generated hydroxyl radicals (OH) is increased.

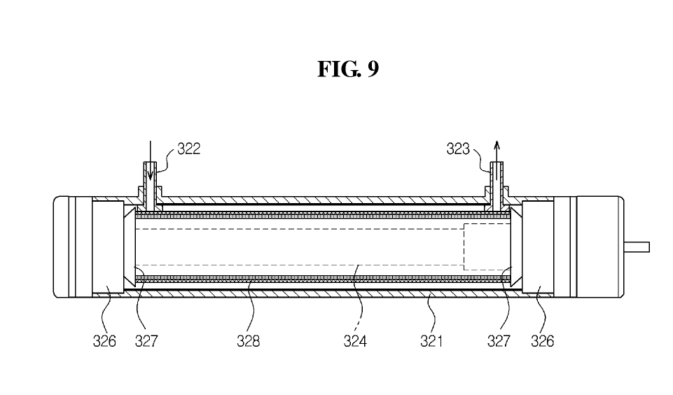

FIG. 9 is a view illustrating the structure of an advanced oxidation process unit in accordance with another embodiment of the present disclosure. The AOP unit of FIG. 9 additionally includes a net-shaped mesh 328 between a lamp 324 and a chemical reactor 321, as compared to the structure of the AOP unit of FIG. 8. Such a mesh 328 may be coated with titanium dioxide (TiO2) serving as a photocatalyst.

FIG. 10 is a view illustrating the structure of an advanced oxidation process unit in accordance with another embodiment of the present disclosure. With reference to FIG. 10, the AOP unit includes a cylindrical chemical reactor 421, the upper and lower surfaces of which are opened, a lamp 424 located within the chemical reactor 421, a cylindrical protective pipe 425 having a smaller length than the lamp 424, both ends of which are opened and a packing 426 provided at each of both ends of the lamp 424. Further, an inlet 422 and an outlet 423 are provided on the outer surface of the chemical reactor 421. Differently from the above-described embodiments, the inlet 422 and the outlet 423 are provided at opposite positions of one end of the chemical reactor 421. Further, the outlet 423 passes through the surface of the chemical reactor 421 and contacts the protective pipe 425.

Since the length of the protective pipe 425 is smaller than the length of the lamp 424, if the lamp 424 is inserted into the protective pipe 425, one end of the lamp 424 passes through the opened end of the protective pipe 425. Here, the end of the lamp 424 is located at the position of the chemical reactor 421 opposite to the position of the inlet 422 and the outlet 423. As described above, if the length of the protective pipe 425 is smaller than the length of the lamp 424 and the opened end of the protective pipe 425 through which the lamp 424 passes is located at the position of the chemical reactor 421 opposite to the position of the inlet 422 and the outlet 423, a photocatalyst reaction path is lengthened, as compared to other cases. In more detail, rinsing water introduced into the chemical reactor 421 through the inlet 422 enters the inside of the protective pipe 425 via a space between the inner surface of the chemical reactor 421 and the outer surface of the protective pipe 425, and is then discharged to the outside of the chemical reactor 421 through the outlet 423 connected to the protective pipe 425. Therefore, as compared to the case in which rinsing water introduced into the chemical reactor 421 through the inlet 422 does not enter the inside of the protective pipe 425, the photocatalyst reaction path is lengthened, photocatalyst reaction time is increased by the lengthened length of the photocatalyst reaction path, and thus an amount of generated hydroxyl radicals (OH) is increased.

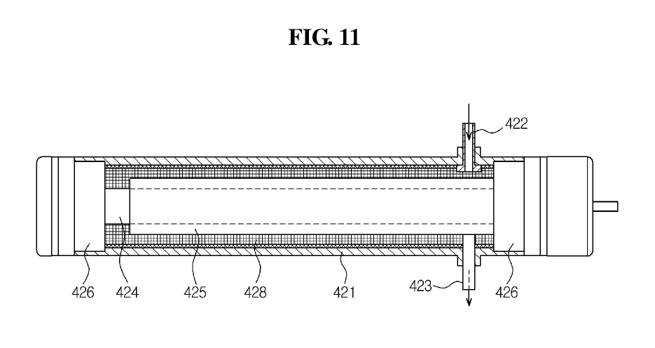

FIG. 11 is a view illustrating the structure of an advanced oxidation process unit in accordance with another embodiment of the present disclosure. The AOP unit of FIG. 11 additionally includes a net-shaped mesh 428 between the outer surface of a protective pipe 425 and the inner surface of a chemical reactor 421, as compared to the structure of the AOP unit of FIG. 10. Such a mesh 428 may be coated with titanium dioxide (TiO2) serving as a photocatalyst.

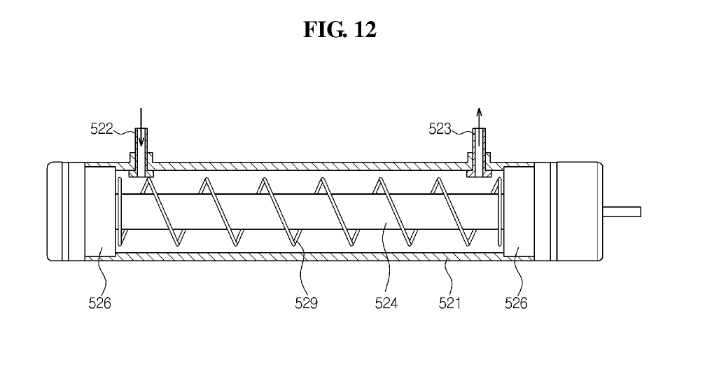

FIG. 12 is a view illustrating the structure of an advanced oxidation process unit in accordance with another embodiment of the present disclosure. With reference to FIG. 12, the AOP unit includes a cylindrical chemical reactor 521, the upper and lower surfaces of which are opened, a lamp 524 located within the chemical reactor 521, a packing 526 provided at each of both ends of the lamp 524 and a spiral channel guide 529 provided along the inner surface of the chemical reactor 521. Rinsing water introduced into the chemical reactor 521 through an inlet 522 flows along the channel guide 529, and is then discharged to the outside of the chemical reactor 521 through an outlet 523. As described above, if the channel guide 529 is installed, rinsing water flows along the inner surface of the reactor 521, a photocatalyst reaction path is lengthened, as compared to other cases, photocatalyst reaction time is increased by the lengthened length of the photocatalyst reaction path, and thus an amount of generated hydroxyl radicals (OH) may be increased. Although FIG. 12 exemplarily illustrates the channel guide 529 as being spiraled, the shape of the channel guide 529 is not limited thereto but may be variously modified.

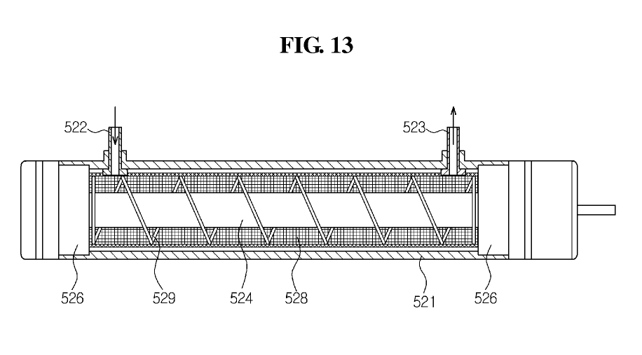

FIG. 13 is a view illustrating the structure of an advanced oxidation process unit in accordance with yet another embodiment of the present disclosure. The AOP unit of FIG. 13 additionally includes a net-shaped mesh 528 between the outer surface of a channel guide 529 and the inner surface of a chemical reactor 521, as compared to the structure of the AOP unit of FIG. 12. Such a mesh 528 may be coated with titanium dioxide (TiO2) serving as a photocatalyst.

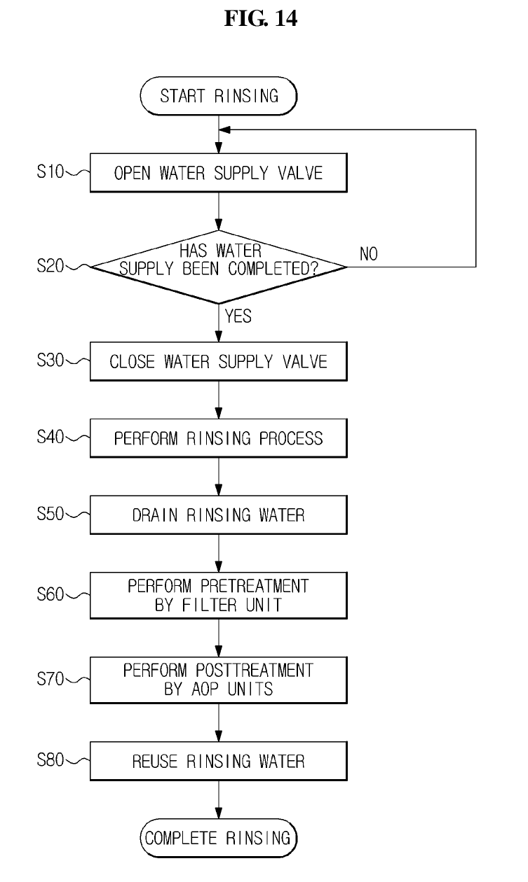

FIG. 14 is a flowchart illustrating a method of purifying and sterilizing the water to reuse, as an example, by using a rinsing operation performed in a washing machine in accordance with an embodiment of the present disclosure.

First, when a user selects a rinsing process, the controller 80 opens the water supply valve 30 (Operation S10) to supply water to the inside of the drum 70 through the water supply pipe.

Thereafter, the controller 80 determines whether or not water supply has been completed (Operation S20). As a result of the determination, upon determining that water supply has not been completed (No in Operation S20), the controller 80 maintains the opened state of the water supply valve 30 so as to continuously perform a water supply process. On the other hand, upon determining that water supply has been completed (Yes in Operation S20), the controller 80 closes the water supply valve 30 (Operation S30).

Thereafter, the controller 80 controls the motor 60 to rotate the drum 70, thus performing the rinsing process (Operation S40).

Thereafter, when the rinsing process has been completed, the controller 80 opens the drain valve 40 to discharge rinsing water to the outside of the drum 70 (Operation S50).

The rinsing water discharged to the outside of the drum 70 passes through pretreatment in which the filter unit 110 physically filters out contaminants from the rinsing water (Operation S60).

The rinsing water pretreated by the filter unit 110 passes through posttreatment in which the AOP units 120 chemically decompose and sterilize a detergent component in the rinsing water (Operation S70).

The rinsing water purified and sterilized by pretreatment and posttreatment is reused in the next rinsing process (Operation S80).

Although it is not shown in FIG. 14, the reused rinsing water may also passes through pretreatment by the filter unit 110 and posttreatment by the AOP units 120, and may be reused in the next rinsing process or be discarded to the outside of the washing machine as needed. Further, in FIG. 14, although the method of purifying and sterilizing the water to reuse is described using the rinsing operation, the present disclosure is not limited thereto. For example, the washing water may be purified and sterilized and may be reused.

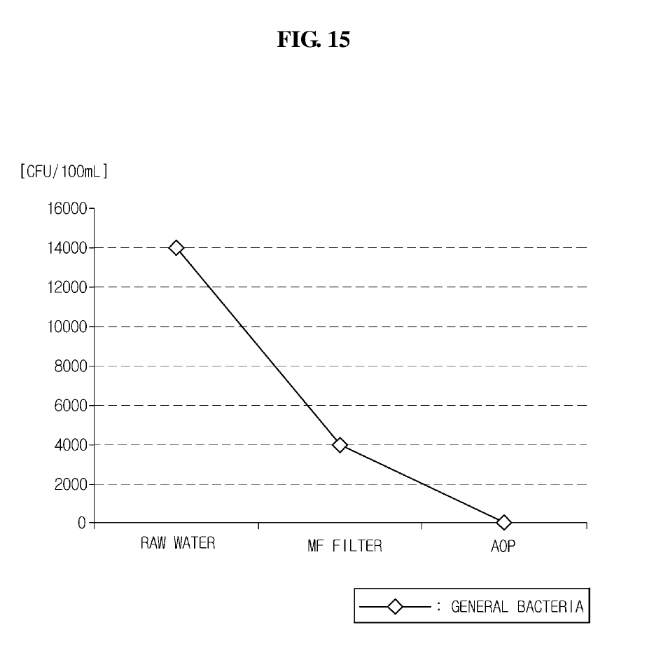

FIG. 15 is a graph illustrating sterilizing effects of a water purification system 100 in accordance with an embodiment of the present disclosure. With reference to FIG. 15, it is understood that, if rinsing water sequentially passes through the filter unit 110 and the AOP units 120, the number of bacteria contained in the rinsing water is rapidly reduced from 16,000 CFU/100 mL (Colony Forming Units per 100 milliliters).

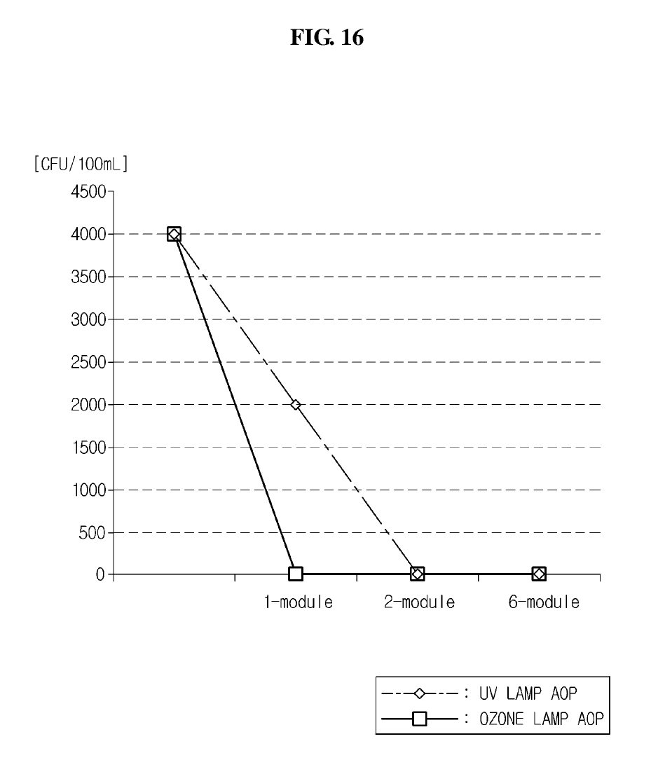

FIG. 16 is a graph illustrating sterilizing effects of the AOP unit 120 using an ultraviolet lamp and the AOP unit 120 using an ozone lamp. With reference to FIG. 16, it is understood that the AOP unit 120 using the ozone lamp has improved sterilizing effects as compared to the AOP unit 120 using the ultraviolet lamp.

As is apparent from the above description, a water purification system and a washing machine having the same in accordance with an embodiment of the present disclosure purify washing water or rinsing water used in a washing process or a rinsing process and then reuse the purified washing or rinsing water in the next washing or rinsing process, thereby saving water.

Further, the water purification system and the washing machine having the same do not require a separate water reservoir to store washing water or rinsing water used in the washing process or the rinsing process, thereby overcoming a spatial limit in design of the washing machine.

Although a few embodiments of the present disclosure have been shown and described, it would be appreciated by those skilled in the art that changes may be made in embodiments without departing from the principles and spirit of the disclosure, the scope of which is defined in the claims and their equivalents.

What is claimed is:

1. A water purification system comprising:
a filter unit to physically filter out contaminants from washing water or rinsing water after a washing process or a rinsing process; and
at least one advanced oxidation process (AOP) unit to purify the washing water or the rinsing water, from which the contaminants have been filtered out, using a photocatalyst to reuse the washing water or the rinsing water.

2. The water purification system according to claim 1, wherein the filter unit is a membrane filter or an electrostatic filter.

3. The water purification system according to claim 1, wherein the at least one AOP unit includes:
a cylindrical chemical reactor, the inner surface of which is coated with the photocatalyst, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor; and
a lamp located within the chemical reactor and to generate ultraviolet light of a wavelength of 185 nm and ultraviolet light of a wavelength of 254 nm.

4. The water purification system according to claim 3, wherein the at least one AOP unit further includes a protective pipe formed of quartz and to surround the lamp to protect the lamp.

5. The water purification system according to claim 4, wherein the protective pipe has a greater length than the length of the lamp.

6. The water purification system according to claim 5, wherein the inlet is provided at one end of the outer surface of the chemical reactor, and the outlet is provided at the other end of the outer surface of the chemical reactor.

7. The water purification system according to claim 4, wherein the protective pipe is a smaller length than the length of the lamp, and is provided with an opened end through which one end of the lamp passes.

8. The water purification system according to claim 7, wherein the inlet and the outlet are opposite to each other at one end of the outer surface of the chemical reactor.

9. The water purification system according to claim 4, further comprising a mesh coated with the photocatalyst and provided between the protective pipe and the chemical reactor.

10. The water purification system according to claim 3, wherein the at least one AOP unit further includes a spiral channel guide provided along the inner surface of the chemical reactor.

11. The water purification system according to claim 10, wherein the at least one AOP unit further includes a mesh coated with the photocatalyst and provided between the channel guide and the inner surface of the chemical reactor.

12. The water purification system according to claim 1, wherein the at least one AOP unit includes:
a cylindrical chemical reactor, the inner surface of which is coated with a reflective material to reflect ultraviolet light generated from a lamp to the inside of the chemical reactor, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor;
the lamp located within the chemical reactor and to generate ultraviolet light of a wavelength of 185 nm and ultraviolet light of a wavelength of 254 nm; and
reflective mirrors provided at both ends of the lamp to reflect the ultraviolet light generated from the lamp to the inside of the chemical reactor.

13. The water purification system according to claim 1, wherein the photocatalyst is titanium dioxide (TiO₂).

14. A washing machine comprising:
a drum to accommodate laundry;
a motor to rotate the drum; and
a water purification system including a filter unit to physically filter out contaminants from washing water or rinsing water discharged from the drum, and at least one advanced oxidation process (AOP) unit to purify the washing water or the rinsing water, from which the contaminants have been filtered out, using a photocatalyst to reuse the washing water or the rinsing water.

15. The washing machine according to claim 14, wherein the filter unit is a membrane filter or an electrostatic filter.

16. The washing machine according to claim 14, wherein the at least one AOP unit includes:
a cylindrical chemical reactor, the inner surface of which is coated with the photocatalyst, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor; and
a lamp located within the chemical reactor and to generate ultraviolet light of a wavelength of 185 nm and ultraviolet light of a wavelength of 254 nm.

17. The washing machine according to claim 16, wherein the at least one AOP unit further includes a protective pipe formed of quartz and to surround the lamp to protect the lamp.

18. The washing machine according to claim 17, wherein the protective pipe has a greater length than the length of the lamp.

19. The washing machine according to claim 18, wherein the inlet is provided at one end of the outer surface of the chemical reactor, and the outlet is provided at the other end of the outer surface of the chemical reactor.

20. The washing machine according to claim 17, wherein the protective pipe has a smaller length than the length of the lamp, and is provided with an opened end through which one end of the lamp passes.

21. The washing machine according to claim 20, wherein the inlet and the outlet are opposite to each other at one end of the outer surface of the chemical reactor.

22. The washing machine according to claim 17, further comprising a mesh coated with the photocatalyst and provided between the protective pipe and the chemical reactor.

23. The washing machine according to claim 16, wherein the at least one AOP unit further includes a spiral channel guide provided along the inner surface of the chemical reactor.

24. The washing machine according to claim 23, wherein the at least one AOP unit further includes a mesh coated with the photocatalyst and provided between the channel guide and the inner surface of the chemical reactor.

25. The washing machine according to claim 14, wherein the at least one AOP unit includes:
a cylindrical chemical reactor, the inner surface of which is coated with a reflective material to reflect ultraviolet light generated from a lamp to the inside of the chemical reactor, an inlet through which the washing water or the rinsing water filtered by the filter unit is introduced into the chemical reactor and an outlet through which the washing water or the rinsing water purified by photocatalyst reaction is discharged from the chemical reactor being provided on the outer surface of the chemical reactor;
the lamp located within the chemical reactor and to generate ultraviolet light of a wavelength of 185 nm and ultraviolet light of a wavelength of 254 nm; and
reflective mirrors provided at both ends of the lamp to reflect the ultraviolet light generated from the lamp to the inside of the chemical reactor.

26. The washing machine according to claim 14, wherein the photocatalyst is titanium dioxide (TiO₂).

27. The water purification system according to claim 3, wherein the at least one AOP unit further includes a mesh coated with the photocatalyst and provided between the lamp and the chemical reactor.

28. The washing machine according to claim 16, wherein the at least one AOP unit further includes a mesh coated with the photocatalyst and provided between the lamp and the chemical reactor

29. A method of purifying and sterilizing washing or rinsing water to reuse in a washing machine, the method comprising:
supplying the washing or rinsing water to an inside of a drum of the washing machine through a water supply pipe;
performing the washing or rinsing operation by rotating the drum;
discharging the washing or rinsing water to the outside of the drum after completing the washing or rinsing operation;
pretreating the discharged water by physically filtering out contaminants from the discharged water through a filter unit;
posttreating the water pretreated by the filter unit by chemically decomposing and sterilizing a detergent component in the pretreated water through at least one AOP unit; and
reusing the water purified and sterilized by pretreatment and posttreatment in a next rinsing process.
